(19) United States
(12) Patent Application Publication
(10) Pub. No.: US 2013/0337344 A1
(43) Pub. Date: Dec. 19, 2013

(54) LITHIUM ION SECONDARY BATTERY

(71) Applicants: Kayo Mizuno, Kariya-shi (JP); Keiichi Hayashi, Kariya-shi (JP); Masaaki Suzuki, Kariya-shi (JP); Takayuki Hirose, Kariya-shi (JP)

(72) Inventors: Kayo Mizuno, Kariya-shi (JP); Keiichi Hayashi, Kariya-shi (JP); Masaaki Suzuki, Kariya-shi (JP); Takayuki Hirose, Kariya-shi (JP)

(73) Assignee: KABUSHIKI KAISHA TOYOTA JIDOSHOKKI, Kariya-shi, Aichi (JP)

(21) Appl. No.: 13/983,946

(22) PCT Filed: Feb. 2, 2012
(86) PCT No.: PCT/JP2012/000831

§ 371 Date: Aug. 6, 2013

(30) Foreign Application Priority Data
Mar. 10, 2011 (JP) 2011053092

(51) Int. Cl. H01M 10/056; H01M 4/505; H01M 4/48; H01M 10/0525

(52) U.S. Cl. CPC H01M 10/056; H01M 10/0525; H01M 4/505; H01M 4/48
USPC 429/332; 429/199

(57) ABSTRACT

In a lithium ion secondary battery using a positive electrode active material made of a lithium manganese based oxide that contains Li and tetravalent Mn and having a crystal structure known as a layered rock salt structure, oxidative and reductive degradation of the non-aqueous electrolyte solution is reduced.

The battery uses a non-aqueous electrolyte solution containing fluorine in one or both of the non-aqueous solvent and the electrolytic salt. For the negative electrode active material, SiOₓ (0.3≦x≦1.6) is used. The combined use of the non-aqueous electrolyte solution containing fluorine and SiOₓ in the negative electrode active material reduces oxidative and reductive degradation of the non-aqueous electrolyte solution.

### TECHNICAL FIELD

The present invention relates to a lithium ion secondary battery.

### BACKGROUND ART

Small, lightweight, and high capacity secondary batteries have been in demand with the development of portable electronic devices such as mobile phones and notebook-sized personal computers, and with the commercial application of electric cars in recent years. High capacity lithium ion secondary batteries that use lithium cobalt oxide (LiCoO₂) as the positive electrode material and a carbon-based material as the negative electrode material are currently meeting the demand. Such lithium ion secondary batteries are being notably used as the power source in a wide range of fields because of their high energy density as well as size and weight reduction potential. However, the production of LiCoO₂, which uses cobalt that is a rare metal (minor metal), will likely be faced with a serious shortage of resource in future. Also because of the high price and large price fluctuations of cobalt, development of a material for the positive electrode that is inexpensive and stably supplied has been sought after.

Lithium manganese composite oxides are considered to be potentially attractive as they are made up of inexpensive elements and manganese (Mn) in their basic composition can be stably supplied. Among these oxides, Li₂MnO₃ that contains only tetravalent manganese ions and no trivalent manganese ions that cause elution of manganese during charge and discharge is attracting attention. Batteries using Li₂MnO₃ have been thought to be not able to be charged and discharged. However, recent research has shown that such batteries, if charged to 4.8 V, can exhibit charge/discharge reversibility. Even so, there is still much scope for improvement in charge and discharge characteristics of batteries using Li₂MnO₃.

A solid solution of Li₂MnO₃ and LiMeO₂ (Me being a transition metal element), xLi₂MnO₃.(1-x)LiMeO₂ (0<x≦1), is being actively researched as a possible material that can improve the charge and discharge characteristics. Li₂MnO₃ can also be represented by the general formula Li(Li_{0.33}Mn_{0.67})O₂, and is known to have the same crystal structure as that of LiMeO₂. Therefore, xLi₂MnO₃.(1-x) LiMeO₂ can sometimes be expressed as Li_{1.33-y}Mn_{0.67-z}Me_{y+z}O₂ (0≦y<0.33, 0≦z<0.67).

A lithium ion secondary battery that uses a lithium manganese composite oxide containing tetravalent manganese ions as the positive electrode active material needs to be charged before use so as to activate the positive electrode active material. In this activation process, lithium ions are released from the positive electrode active material of the lithium manganese composite oxide and oxygen is desorbed, whereby the non-aqueous electrolyte solution undergoes oxidative degradation. Another problem was that when stored in a charged state in a high temperature storage test, the non-aqueous electrolyte solution degrades on the surface of the positive electrode, as the positive electrode side is placed in an oxidizing atmosphere. The non-aqueous electrolyte solution undergoing oxidative degradation forms an insulating film on the electrode surface, whereby the internal resistance is increased and the charge and discharge capacity after the storage is lowered.

Japanese Unexamined Patent Application Publication No. 2004-296315 discloses a technique of using a lithium-containing composite oxide such as LiCoO₂ or LiNiO₂, which has high-voltage and high-capacity potential, as the positive electrode active material, and a lithium salt containing fluorine and a group 2 element salt containing fluorine as the electrolytic salt (supporting electrolyte) of the non-aqueous electrolyte solution. In Japanese Unexamined Patent Application Publication No. 2004-296315 it is stated that anions containing fluorine are stable in an oxidizing or reductive atmosphere. Japanese Unexamined Patent Application Publication No. 2008-16424 discloses a technique of using a non-aqueous electrolyte solution, which includes an electrolytic salt containing lithium borate and fluorine, and a non-aqueous solvent containing fluorine (such as fluoroethylene carbonate), in a lithium ion secondary battery.

In Japanese Unexamined Patent Application Publication No. 2008-16424 it is stated that the use of such a non-aqueous electrolyte solution improves the high temperature storage characteristics and high temperature cycle characteristics of the lithium ion secondary battery.

However, in the examples of embodiment in Japanese Unexamined Patent Application Publication No. 2008-16424, graphite is used as the negative electrode active material. In lithium ion secondary batteries that use a carbon material such as graphite as the negative electrode active material, the solvent in the non-aqueous electrolyte solution undergoes reductive degradation on the surface of the negative electrode while charging and forms an insulating film called SEI (Solid Electrolyte Interface) on the negative electrode surface. The SEI is mainly composed of LiF, LiCO₃, and the like. As lithium is irreversibly coupled on the inside these substances, formation of the SEI reduces the amount of lithium available for charging and discharging and increases the irreversible capacity. Formation of SEI would also cause the problem of increased internal resistance of the battery.

### SUMMARY OF INVENTION

### Technical Problem

The problems associated with the formation of SEI may be solved by not using a carbon material such as the graphite mentioned above as the negative electrode active material. However, neither of Japanese Unexamined Patent Application Publication No. 2004-296315 and No. 2008-16424 discloses a battery that uses a positive electrode active material that generates oxygen in an activation process. Merely selecting a material other than graphite as the negative electrode active material could hardly reduce degradation of the non-aqueous electrolyte solution on the positive electrode surface, which occurs in the case with using a positive electrode active material that generates oxygen during the activation process.

The present invention was made in view of these circumstances, its object being to reduce oxidative and reductive degradation of non-aqueous electrolyte solution in a lithium ion secondary battery with a positive electrode active material that has high-capacity potential but requires an activation process.

### Solution to Problem

To achieve the above object, the present invention provides a lithium ion secondary battery, including: a positive electrode including a positive electrode active material made of a lithium manganese based oxide containing lithium (Li) and tetravalent manganese (Mn) and having a crystal structure known as a layered rock salt structure; a negative electrode including a negative electrode active material made of a silicon oxide represented by SiOₓ (0.3≦x≦1.6); and an electrolyte including a non-aqueous solvent and an electrolytic salt, the electrolyte containing fluorine (F) in at least one of the non-aqueous solvent and the electrolytic salt.

### Advantageous Effect of the Invention

The lithium ion secondary battery of the present invention uses a lithium manganese based oxide that needs activation to function as the positive electrode active material. The battery uses SiOₓ as the negative electrode active material. The battery uses a non-aqueous electrolyte solution that contains fluorine (F) in at least one of the non-aqueous solvent and the electrolytic salt. Hereinafter, unless otherwise stated, the fluorine element (F) will be referred to simply as fluorine.

The non-aqueous electrolyte solution containing fluorine has improved oxidation resistance. This is considered to be due to the electrophilicity of fluorine contained in the non-aqueous electrolyte solution. With the improved oxidation resistance, oxidative degradation of the non-aqueous electrolyte solution is reduced.

Non-aqueous electrolyte solution containing fluorine has poor reduction resistance. If graphite (MAG) is used as the negative electrode active material, for example, the electrolyte undergoes reductive degradation at edge portions of MAG. SiOₓ, however, does not have edge portions such as those of MAG but has an inactive silicate phase. Moreover, SiOₓ has a higher reaction potential than MAG. Therefore, reductive degradation of the non-aqueous electrolyte solution can be reduced by using SiOₓ as the negative electrode active material. Thus, in the lithium ion secondary battery of the present invention, oxidative degradation of the non-aqueous electrolyte solution is reduced by the use of fluorine contained in the solution, and at the same time, reductive degradation of the non-aqueous electrolyte solution is reduced despite the use of the fluorine in the solution, by the use of SiOₓ as the negative electrode active material. Accordingly, the lithium ion secondary battery of the present invention can reduce oxidative and reductive degradation of the non-aqueous electrolyte solution despite the use of the lithium manganese based oxide that requires activation to function as the positive electrode active material.

### BRIEF DESCRIPTION OF DRAWINGS

FIG. 1 is a graph showing the capacity recovery rates after high temperature storage of lithium ion secondary batteries according to Examples 1 and 2 of embodiment and a comparative example; and

FIG. 2 is a graph showing the rate of increase in internal resistance after high temperature storage of lithium ion secondary batteries according to Examples 1 and 2 of embodiment and a comparative example.

### DESCRIPTION OF EMBODIMENTS

The non-aqueous electrolyte solution of the lithium ion secondary battery according to the present invention contains a non-aqueous solvent and an electrolytic salt dissolved in the solvent. At least one of the non-aqueous solvent and the electrolytic salt includes fluorine. Hereinafter, the non-aqueous solvent that contains fluorine will be referred to as “fluorine-containing non-aqueous solvent”, and the electrolytic salt that contains fluorine will be referred to as “fluorine-containing electrolytic salt”. The fluorine-containing non-aqueous solvent and the fluorine-containing electrolytic salt will be referred to collectively as “fluorine-containing material”.

An example of the fluorine-containing electrolytic salt that can be used preferably is a lithium salt containing fluorine. Preferably, for example, it is at least one of fluorine-containing lithium salts selected from a group consisting of LiPF₆, LiBF₄, LiClO₄, LiAsF₆, LiN(SO₂CF₃)₂, LiN(SO₂C₂F₅)₂, LiC(SO₂CF₃)₃, LiPF₄(CF₃)₂, LiPF₃(C₂F₅)₃, LiPF₃(CF₃)₃, LiPF₃(iso-C₃F₇)₃, LiPF₅(iso-C₃F₇), LiSbF₆, LiCF₃SO₃, LiC₄F₉SO₃, LiCF₃CO₂, Li₂C₂F₄ (SO₃)₂, LiN(CF₃SO₂)₂, and LiCₙF₂ₙ₊₁SO₃ (n≧2). LiPF₆ and LiC₄F₉SO₃ and the like are particularly preferable, as they offer good charge and discharge characteristics. Note that, the non-aqueous electrolyte solution of the lithium ion secondary battery according to the present invention may contain an electrolytic salt other than the fluorine-containing electrolytic salt. LiClO₄, or LiI, or the like for example, either alone or as a blend of two or more, may be used with one or more of the fluorine-containing electrolytic salts listed above.

For the fluorine-containing non-aqueous solvent, a type of fluorinated ethylene carbonates such as fluorinated ethylene carbonate, difluorinated ethylene carbonate, trifluorinated ethylene carbonate, and the like, can favorably be used. An example of fluorinated ethylene carbonate is 4-fluoro-1,3-dioxolane-2-one (fluoroethylene carbonate, FEC). Examples of difluorinated ethylene carbonate, are 4-methyl-5-fluoro-1,3-dioxolane-2-one, and 4,5-difluoro-1,3-dioxolane-2-one, difluoroethylene carbonate (DFEC). Examples of trifluorinated ethylene carbonate are trifluoropropylene carbonate, 4-trifluoromethyl-1,3-dioxolane-2-one, and trifluoromethylene ethylene carbonate. FEC, particularly, can be used preferably in terms of oxidation resistance.

The non-aqueous electrolyte solution of the lithium ion secondary battery according to the present invention may have a composition similar to conventional solutions except that it contains the fluorine-containing material. It may contain, for example, a non-aqueous solvent and an electrolytic lithium metal salt dissolved in the solvent. A commonly known non-aqueous solvent may also be used in addition to the fluorine-containing non-aqueous solvents mentioned above. Solvents containing chain esters are preferable in terms of load characteristics. Examples include organic solvents such as chain carbonates, such as, typically, dimethyl carbonate, diethyl carbonate, and ethyl methyl carbonate, ethyl acetates, and methyl propionates. These chain esters may be used either alone or as a blend of two or more. The chain ester should preferably occupy 50 vol % or more, and in particular, 65 vol % or more, of the entire non-aqueous solvent, in order to improve low temperature characteristics. Also, in the case where the fluorine-containing non-aqueous solvent is made of one of the fluorinated ethylene carbonates mentioned above, 50 vol % or more, and in particular, 65 vol % or more, of the entire non-aqueous solvent should preferably be taken up by chain esters containing fluorinated ethylene carbonates.

To improve the discharge capacity, the non-aqueous solvent should preferably include an ester having a high dielectric constant (of 30 or more) mixed in the chain ester mentioned above. Specific examples of such esters include, for example, cyclic carbonates such as, typically, ethylene carbonate, propylene carbonate, butylene carbonate and vinylene carbonate, γ-butyrolactone, and ethylene glycol sulfite. Esters having a cyclic structure, such as ethylene carbonate and propylene carbonate are particularly preferable. Such esters having a high dielectric constant should preferably take up 10 vol % or more, in particular 20 vol % or more, of the entire non-aqueous solvent, taking account of the discharge capacity. The ester content should preferably be 40 vol % or less, in particular, 30 vol % or less, in terms of the load characteristics.

The density of the electrolyte in the non-aqueous electrolyte solution should preferably be, but not particularly limited to, about 0.3 to 1.7 mol/dm³, and more preferably 0.4 to 1.5 mol/dm³. The density of the electrolyte here refers to the density of the entire electrolyte including the fluorine-containing electrolytic salt(s). The non-aqueous electrolyte solution may also contain an aromatic compound in order to enhance battery safety performance and storage characteristics. Examples of aromatic compounds that can favorably be used include benzenes having an alkyl radical such as cyclohexylbenzene or t-butylbenzene, biphenyls, and fluorobenzenes.

The density of the fluorine-containing material in the non-aqueous electrolyte solution may vary depending on the type of the fluorine-containing material. If a fluorine-containing electrolytic salt only is to be used as the fluorine-containing material, for example, it should preferably be about 1 M. If a fluorine-containing non-aqueous solvent only is to be used, the density should preferably be about 40 vol %. If a fluorine-containing electrolytic salt and a fluorine-containing non-aqueous solvent are to be used together, the density of the fluorine-containing electrolytic salt should preferably be about 1 M and the density of the fluorine-containing non-aqueous solvent should preferably be about 30 vol %. If the content of the fluorine-containing material is far below the above-specified value, the effects of the fluorine-containing material may hardly be achieved. If the content largely exceeds the above-specified value, the effects may be reduced, and in some cases the internal resistance of the lithium ion secondary battery may rise.

The lithium ion secondary battery of the present invention includes a positive electrode, a negative electrode, and a non-aqueous electrolyte solution. The battery also includes a separator interposed between the positive electrode and the negative electrode, as with commonly known lithium ion secondary batteries.

The positive electrode includes a positive electrode active material made of a lithium manganese based oxide containing lithium (Li) and tetravalent manganese (Mn) and having a crystal structure known as a layered rock salt structure. This positive electrode active material has a basic composition of a lithium manganese based oxide represented by the formula: xLi₂M₁O₃.(1-x)LiM₂O₂ (0≦x≦1), wherein M₁ is one or more metal elements at least containing tetravalent Mn, and M₂ is two or more metal elements at least containing tetravalent Mn. Not to mention, the lithium manganese based oxide also includes composite oxides having a slightly different composition from the above formula due to inevitable loss of L₁, M₁, M₂, or O. The manganese in the resultant composite oxide may have a lower average oxidation number because of the presence of Mn having a valence of less than 4, the tolerable range of valence being 3.8 to 4. At least one of the metal elements selected from the group of Cr, Fe, Co, Ni, Al, and Mg may be used in M₁ and M₂ as a metal element other than the tetravalent Mn. There should preferably be 1.1 times more Li than Mn in the above formula.

This positive electrode active material can be manufactured by performing a material mixture preparation step of preparing a material mixture, wherein a metal compound material containing one or more metal elements at least including Mn is mixed with a molten salt material including lithium hydroxide but substantially no other compounds and containing more lithium than in the theoretical composition of the target composite oxide, and a melting reaction step of melting the material mixture so that the mixture undergoes reaction at a temperature higher than a melting point of the molten salt material. With the use of the molten salt including lithium hydroxide, a lithium manganese based oxide primarily containing Li and tetravalent Mn and having a layered rock salt structure is produced as a main product.

This material mixture is then subjected to a high temperature of more than the melting point of the lithium hydroxide to undergo reaction in the molten salt, whereby fine particles of composite oxide are obtained. This is because the material mixture mixes with the molten salt uniformly by alkali fusion. Since the reaction occurs in the molten salt that substantially consists of lithium hydroxide, the crystal growth rate is low even under the high reaction temperature, so that a composite oxide having a primary particle size of nanometers is obtained.

One or more metal compounds selected from oxides, hydroxides, and metal salts containing one or more metal elements at least including Mn are used as the metal compound material that supplies tetravalent Mn. The metal compound material must contain the metal compound(s). Specific examples of the metal compound include manganese dioxide (MnO₂), manganese sesquioxide (Mn₂O₃), manganese monoxide (MnO), trimanganese tetraoxide (Mn₃O₄), manganese hydroxide (Mn(OH)₂), manganese oxyhydroxide (MnOOH), and oxides, hydroxides, and metal salts of these having part of Mn substituted with Cr, Fe, Co, Ni, Al, Mg, and the like. One of these, or two or more of these may be used as the essential metal compound(s). MnO₂, in particular, is preferable, as relatively high purity MnO₂ is readily available.

Mn in the metal compound need not necessarily be tetravalent and may have a valence of less than 4. This is because the reaction progresses in a high oxidation state so that divalent or trivalent Mn eventually becomes tetravalent. The same applies to the transition elements that substitute Mn.

A second metal compound, which is selected from oxides, hydroxides, and metal salts, may be used as the compound containing a metal element for substituting part of Mn. Specific examples of the second metal compound include cobalt oxide (CoO, CO₃O₄), cobalt nitrate (Co(NO₃)₂.6H₂O), cobalt hydroxide (Co(OH)₂), nickel oxide (NiO), nickel nitrate (Ni(NO₃)₂.6H₂O), nickel sulfate (NiSO₄.6H₂O), aluminum hydroxide (Al(OH)₃), aluminum nitrate (Al(NO₃)₃.9H₂O), copper oxide (CuO), copper nitrate (Cu(NO₃)₂.3H₂O), and calcium hydroxide (Ca(OH)₂). One of these, or two or more of these may be used as the second metal compound(s).

The melting reaction step is a step of melting the material mixture so that it undergoes reaction. The reaction temperature is the temperature of the material mixture during the melting reaction step and it may be the melting point of the molten salt material or higher. With a temperature lower than 500° C., however, it is difficult to produce the desired composite oxide containing tetravalent Mn with good selectivity because of insufficient reaction activity of the molten salt. With a reaction temperature of 550° C. or higher, composite oxide with high crystallinity can be obtained. The upper limit of the reaction temperature should preferably be lower than the decomposition temperature of the lithium hydroxide, not higher than 900° C., and more preferably not higher than 850° C. If manganese dioxide is used as the metal compound that supplies Mn, the reaction temperature should preferably be in the range of 500 to 700° C., and more preferably 550 to 650° C. If the reaction temperature is too high, the molten salt undergoes decomposition reaction, which is not desirable. Sufficient reaction of the material mixture can be achieved if it is kept under this reaction temperature for 30 min or more, more preferably for 1 to 6 hours.

The melting reaction step may be carried out in an oxygen-containing atmosphere such as, for example, air atmosphere, or gas atmosphere containing oxygen and/or ozone gas, so that a single phase composite oxide containing tetravalent Mn is more readily obtained. With an atmosphere containing oxygen gas, the oxygen density should preferably be 20 to 100 vol %, and more preferably 50 to 100 vol %. The higher the oxygen density, the smaller the particle diameter of the synthesized composite oxide tends to be.

The composite oxide obtained by the production method described above has the layered rock salt structure. That the composite oxide substantially has the layered rock salt structure can be confirmed by an X-ray diffraction (XRD) or electron diffraction analysis. The layered structure can also be observed in a high resolution image obtained by high-resolution transmission electron microscopy (TEM). The resultant composite oxide can be represented by the formula: xLi₂M₁O₃.(1-x)LiM₂O₂ (0≦x≦1), wherein M₁ is a metal element at least containing tetravalent Mn, and M₂ is a metal element at least containing tetravalent Mn. An atomic ratio of 60% or less, furthermore 45% or less, of lithium may be substituted with hydrogen (H). While M₁ should preferably be mostly tetravalent Mn, less than 50%, furthermore less than 80%, of M₁ may be substituted with other metal elements.

The metal elements other than tetravalent Mn constituting M₁ and M₂ should preferably be selected from Ni, Al, Co, Fe, Mg, and Ti, in terms of the charge and discharge capacities of the battery using them as the electrode material. Not to mention, the lithium manganese based oxide also includes composite oxides having a slightly different composition from the above formula due to inevitable loss of L₁, M₁, M₂, or O. Therefore, M₁ or Mn contained in M₂ may have a lower oxidation number, the tolerable range of valence being 3.8 to 4.

A specific example is a solid solution containing one or two or more of Li₂MnO₃, LiNi_{1/3}Co_{1/3}Mn_{1/3}O₂, and LiNi_{0.5}Mn_{0.5}O₂. Part of Mn, Ni, and Co may be substituted with other metal elements. The resultant composite oxide as a whole may have the oxide specified herein as the basic composition, and may have a slightly different composition from the above formula due to inevitable loss of metal elements or oxygen.

The positive electrode of the lithium ion secondary battery according to the present invention includes a current collector and an active material layer bonded on the current collector. The active material layer may be formed by mixing a positive electrode active material made of a lithium manganese based oxide having a crystal structure known as a layered rock salt structure, a conductive additive, binder resin, and a suitable amount of organic solvent added as required into a slurry, applying it on the current collector by any of roll coating, dip coating, doctor blading, spray coating, or curtain coating, and curing the binder resin after that.

For the current collector, it is common to use metal mesh or foil. Examples include porous or non-porous conductive substrates made of a metal material such as stainless steel, titanium, nickel, aluminum, and copper, or conductive resin. Examples of porous conductive substrates include mesh, net, punched sheet, lath, porous body, foam, or fibrous molded article such as non-woven fabric. Examples of non-porous conductive substrates include foil, sheet, and film. Materials other than metal, such as carbon sheet or the like, may also be used for the current collector.

The conductive additive is added for enhancing the conductivity of the electrode. As the conductive additive, any of carbon black, which is fine particles of carbon, Massive Artificial Graphite (MAG), acetylene black (AB), Ketjen black (KB), vapor grown carbon fiber (VGCF) and the like can be added either alone or as a combination of two or more of these. The amount of conductive additive to be used may be, as commonly known, but not limited to, about 20 to 100 parts by mass relative to 100 parts by mass of positive electrode active material. The binder resin binds the positive electrode active material and the conductive additive together. Any of fluorine-containing resins such as polyfluorovinylidene, polytetrafluoroethylene, or fluorine rubbers, or thermoplastic resins such as polypropylene, polyethylene, and the like may be used.

For the organic solvent used in the slurry to adjust viscosity, any of N-methyl-2-pyrrolidone (NMP), methanol, methyl isobutyl ketone (MIBK), and the like may be used.

The negative electrode of the lithium ion secondary battery according to the present invention includes a current collector and an active material layer bonded on the current collector. As the negative electrode active material, a powder of silicon oxide represented by SiOₓ (0.3≦x≦1.6) is used. It is known that SiOₓ can be thermally decomposed into Si and SiO₂. This is called disproportional reaction. Homogeneous solid silicon monoxide (SiO) containing Si and O in a ratio of generally 1:1 will separate into two phases, Si phase and SiO₂ phase, as the solid reacts internally. The Si phase obtained by the separation is very finely particulated. The SiO₂ (silicate) phase that covers the Si phase functions to reduce degradation of the non-aqueous electrolyte solution. As mentioned in the foregoing, in the case with using a fluorine-containing material for the non-aqueous electrolyte solution, and MAG as the negative electrode active material, of a lithium ion secondary battery, there was the problem of reductive degradation of the non-aqueous electrolyte solution at the edge portions of MAG to form SEI, as a result of which the internal resistance of the battery would rise. SiOₓ, in contrast, has no edge portions such as those in MAG. Therefore, reductive degradation of the non-aqueous electrolyte solution can be reduced by using SiOₓ₂ as the negative electrode active material. The battery with SiOₓ alone as the negative electrode active material may show insufficient cycle characteristics, in which case it may be desirable to use other carbon materials such as MAG in combination with SiOₓ. The current collector, conductive additive, binder resin, and organic solvent for the positive electrode can also be used for the negative electrode.

The separator should preferably have sufficient strength and a large capacity to hold non-aqueous electrolyte solution. A porous film or non-woven cloth of polyolefin such as polypropylene, polyethylene, propylene-ethylene copolymer, and the like, having a thickness of 10 to 50 μm, for example, can favorably be used. Battery characteristics such as charge and discharge cycles and high temperature storage life can readily deteriorate with the use of a thin separator of, in particular, 10 to 20 μm. However, the lithium ion secondary battery with the composite oxide mentioned above as the positive electrode active material and the fluorine-containing material mentioned above in the non-aqueous electrolyte solution has excellent stability, so that the battery can be operated stably even with the use of such a thin separator.

The lithium ion secondary battery configured with the elements described above may have various shapes such as cylindrical, laminated, coin-shaped, and so on. In any design, an electrode assembly is formed, with the separator interposed between the positive electrode and the negative electrode. Positive and negative current collectors are connected to positive and negative terminals that extend to the outside with current collecting leads or the like, and this electrode assembly is impregnated with the non-aqueous electrolyte solution described above and sealed in a battery case, to form the lithium ion secondary battery.

To use the lithium ion secondary battery of the present invention, the battery is first charged to activate the positive electrode active material. Since the battery uses a positive electrode active material made of a lithium manganese based oxide having a layered rock salt structure, lithium ions are released and oxygen is generated during the initial charge. Therefore, the charge should preferably be performed before sealing the battery case.

The lithium ion secondary battery of the present invention described above can favorably be used in the fields of communication equipment or information-related equipment such as mobile phones and personal computers, as well as in the field of automobiles. The lithium ion secondary battery can be used as the power source of an electric car, for example, by being mounted in a vehicle.

Hereinafter, the present invention will be described in more specific terms through description of examples of embodiment.

### EXAMPLES OF EMBODIMENT

### Example 1

<Fabrication of Positive Electrode>

Lithium hydroxide monohydrate LiOH.H₂O (8.4 g, 0.20 mol), as the molten salt material, and manganese dioxide MnO₂ (1.74 g, 0.02 mol), as the metal compound material, were mixed to obtain a material mixture. As the target product is Li₂MnO₃, the ratio of Li in the target product to Li in the molten salt material (Li in the target product/Li in the molten salt material) was 0.2 (0.04 mol/0.2 mol), assuming that Mn in the manganese dioxide was all supplied to Li₂MnO₃.

The material mixture was put in a crucible, which was placed inside an electric furnace of 700° C., and the mixture was heated at 700° C. for two hours in vacuum. The material mixture melted into molten salt, with a black product precipitated.

The crucible containing the molten salt was then cooled down to room temperature inside the electric furnace, after which it was taken out of the electric furnace. After the molten salt has been sufficiently cooled and solidified, the entire crucible was immersed in 200 mL ion exchange water, and the content was stirred to dissolve the solidified molten salt into water. As the black product was insoluble to water, the resultant liquid was a black suspension. The black suspension was filtered to obtain clear filtrate and a black solid material on the filter paper. The filtered material was thoroughly cleaned with acetone and further filtered. The black solid substance after the cleaning was dried at 120° C. for twelve hours in vacuum, after which it was pulverized with the use of a mortar and pestle.

The black powder thus obtained was subjected to an X-ray diffraction (XRD) measurement using CuKα. The XRD measurement revealed that the resultant black powder had a layered rock salt structure. Through an emission spectrophotometric analysis using ICP and an analysis of average valence of Mn by oxidation-reduction titration, the composition of the resultant black powder was confirmed to be Li₂MnO₃.

The evaluation of valence of Mn was carried out as follows: A 0.05 g sample was put in a triangular flask, an accurately measured amount (40 mL) of 1% sodium oxalate solution was added, and 50 mL of H₂SO₄ was further added, after which the sample was dissolved in a water bath at 90° C. in a nitrogen gas atmosphere. Potassium permanganate (0.1 N) was dropped to this solution until the solution took a pinkish color which indicated the end point of the titration (titration amount: V₁). Sodium oxalate solution (20 mL, 1%) was accurately measured into another flask, and potassium permanganate (0.1 N) was dropped until the end point as set out above (titration amount: V₂). Using the equation below, and from V₁ and V₂, the amount of oxalate consumed for the reduction of high-valence Mn to Mn²⁺ was calculated as the amount of oxygen (active oxygen). The equation is as follows:

Amount of active oxygen (%)={(2×V₂−V₁)×0.00080/amount of sample}×100. The average valence of Mn was then calculated from the amount of Mn in the sample (ICP measured value) and the amount of active oxygen.

The positive electrode active material thus obtained, Ketjen black (KB) as a conductive additive, and polyfluorovinylidene (PVdF) as a binder resin were mixed at a mass ratio of 88:6:6. This mixture was then coated on a sheet-like current collecting aluminum foil. The current collecting foil coated with the mixture was dried at 120° C. for more than 12 hours in vacuum. A nickel tab was attached to a corner portion of the current collecting foil by resistance welding. This corner portion was covered with a resin film.

<Fabrication of Negative Electrode>

A powder of SiO (made by Sigma-Aldrich Japan, mean particle diameter of 5 μm) was heated at 900° C. for two hours to prepare a powder of SiO with a mean particle diameter of 5 μm. By such heat treatment, homogeneous solid silicon monoxide (SiO) containing Si and O in a ratio of generally 1:1 separates into two phases, Si phase and SiO₂ phase, as the solid reacts internally. The Si phase obtained by the separation is very finely particulated.

To 42 parts by mass of the thus obtained SiOₓ powder were mixed 40 parts by mass of MAG powder and 3 parts by mass of Ketjen black (KB) powder as conductive additives, and polyamideimide (PAI) as a binder resin, to prepare a slurry. The ratio of solid components in the composition of the slurry was SiOₓ powder: MAG powder: KB: PAI=42:40:3:15. This slurry was applied on the surface of a 20 μm thick electrolytic copper foil (current collector) using a doctor blade, to form a negative electrode active material layer on the copper foil. This was followed by drying at 80° C. for 20 minutes to remove the organic solvent from the negative electrode active material layer by volatilization. After the drying, the current collector and the negative electrode active material layer were firmly joined together with a roll press. This was heated at 200° C. for two hours to set, to form an electrode with an active material layer of about 15 μm. A nickel tab was attached to a corner portion of the negative electrode by resistance welding. This corner portion was covered with a resin film.

<Preparation of Non-Aqueous Electrolyte Solution>

Fluoroethylene carbonate (fluorine-containing non-aqueous solvent) and LiPF₆ (fluorine-containing electrolytic salt) were used as the fluorine-containing material. More specifically, LiPF₆ was dissolved at a concentration of 1 M in a mixed solvent of fluoroethylene carbonate (FEC) and ethyl methyl carbonate (EMC) at a volume ratio of 3:7, as the non-aqueous electrolyte solution.

<Fabrication of Lithium Ion Secondary Battery>

A laminated cell was fabricated using the positive electrode, the negative electrode, and the non-aqueous electrolyte solution described above. The laminated cell was configured with an electrode plate assembly made up of positive and negative electrodes and a separator, a laminate film enveloping and sealing the electrode plate assembly, and the non-aqueous electrolyte solution poured into the laminate film. The electrode plate assembly was formed by stacking one negative electrode upon one positive electrode, with one separator interposed therebetween. The positive and negative electrodes are configured as described above. The separator is a rectangular, polypropylene resin sheet. The electrode plate assembly was formed such that the positive electrode, separator, and negative electrode were stacked upon one another in this order, with the active material layers of positive and negative electrodes facing each other via the separator.

The laminate film that enveloped and sealed the electrode plate assembly was bag-shaped, with four sides air-tightly sealed. The tabs of both electrodes partly extend to the outside from one of the four sides of the laminate film for external electrical connection. The laminate film is filled with the non-aqueous electrolyte solution described above.

The laminated cell was thus formed, by inserting the electrode plate assembly into the bag-shaped laminate film with three sealed sides, filling the laminate film with the non-aqueous electrolyte solution, and sealing the remaining one side. The cell was then subjected to constant current constant voltage charge (0.2 C, 4.6 V) to activate the positive electrode active material, and was complete as a lithium ion secondary battery.

<Tests>

### <Calculation of Capacity Recovery Rate>

A high temperature storage test of storing the lithium ion secondary battery at 80° C. for five days was carried out. The 1 C discharge capacity before the high temperature storage test, and the 1 C discharge capacity after a charge up to an SOC of 100% following full discharge after the high temperature storage were measured, and the capacity recovery rate was calculated from the following equation.

Capacity recovery rate=100×(1 C discharge capacity after a charge up to an SOC of 100% following full discharge after storage)/(1 C discharge capacity before storage)

### <Calculation of Rate of Increase in Internal Resistance>

A high temperature storage test of storing the lithium ion secondary battery at 80° C. for five days was carried out. The battery internal resistances before and after the high temperature storage test were measured, and the rate of increase in the internal resistance was calculated from the following equation.

Rate of increase in internal resistance=100×(resistance after storage−resistance before storage)/resistance before storage

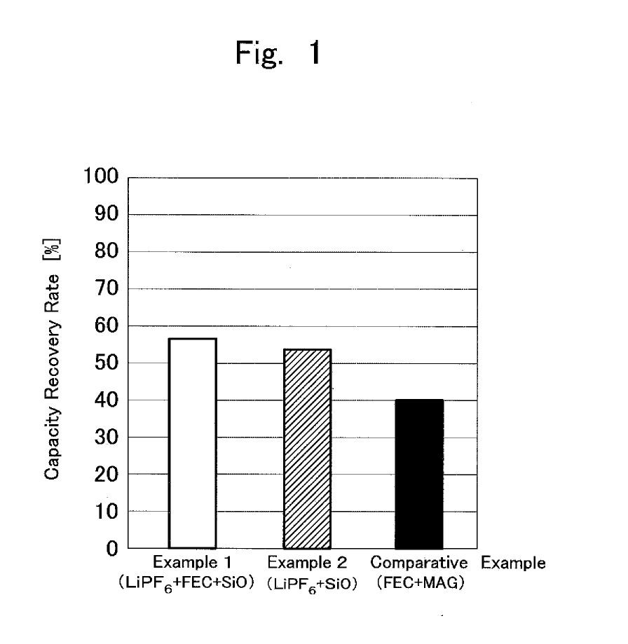

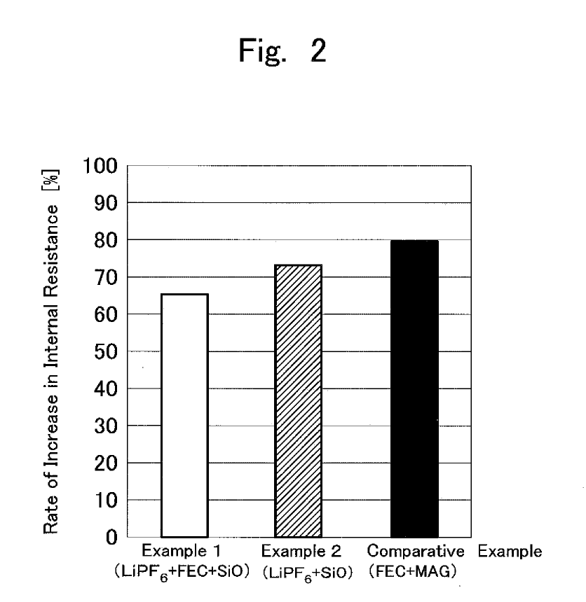

The results are shown in FIG. 1 and FIG. 2, respectively.

### Example 2

A lithium ion secondary battery was fabricated similarly to Example 1, except that the non-aqueous solvent of the non-aqueous electrolyte solution was made of EC and EMC and did not contain FEC. Namely, the lithium ion secondary battery of Example 2 contains Li₂MnO₃ as the positive electrode active material, SiOₓ as the negative electrode active material, and a fluorine-containing electrolytic salt (LiPF₆) in the non-aqueous electrolyte solution, while it does not contain a fluorine-containing non-aqueous solvent (FEC). The capacity recovery rate and the rate of increase in internal resistance were calculated similarly to Example 1, except that the battery used was this lithium ion secondary battery. The results are shown in FIG. 1 and FIG. 2, respectively.

### Comparative Example

A lithium ion secondary battery was fabricated similarly to Example 1, except that the negative electrode active material was made of MAG alone. Namely, the lithium ion secondary battery of Comparative Example contains Li₂MnO₃ as the positive electrode active material, MAG as the negative electrode active material, and a fluorine-containing electrolytic salt (LiPF₆) and a fluorine-containing non-aqueous solvent (FEC) in the non-aqueous electrolyte solution, while it does not contain SiOₓ as the negative electrode active material. The capacity recovery rate and the rate of increase in internal resistance were calculated similarly to Example 1, except that the battery used was this lithium ion secondary battery. The results are shown in FIG. 1 and FIG. 2, respectively.

<Evaluation>

As is clear from FIG. 1 and FIG. 2, the lithium ion secondary batteries of Examples 1 and 2 showed an increase in the capacity recovery rate, and a decrease in the rate of increase in the internal resistance, as compared to the battery of Comparative Example. This is considered to be due to the cooperative effect of the non-aqueous electrolyte solution containing a fluorine-containing material and the use of SiOₓ as the negative electrode active material. The lithium ion secondary battery of Example 1 showed a higher capacity recovery rate and a lower rate of increase in the internal resistance than the battery of Example 2. This is considered to be because, while the non-aqueous electrolyte solution of the lithium ion secondary battery of Example 1 contains both of the fluorine-containing electrolytic salt and the fluorine-containing non-aqueous electrolyte solution, the lithium ion secondary battery of Example 2 contains only the fluorine-containing electrolytic salt. Thus it has been shown that with the use of a combination of a fluorine-containing electrolytic salt and a fluorine-containing non-aqueous electrolyte solution as the fluorine-containing material of the non-aqueous electrolyte solution, the lithium ion secondary battery can have a high capacity recovery rate and a lower rate of increase in the internal resistance.

### DRAWINGS

FIG. 1

Capacity Recovery Rate [%]

Example 1

Example 2

Comparative Example

FIG. 2

Rate of Increase in Internal Resistance [%]

Example 1

Example 2

Comparative Example

1-6. (canceled)

7. A lithium ion secondary battery, comprising:
a positive electrode including a positive electrode active material made of a lithium manganese based oxide containing lithium (Li) and tetravalent manganese (Mn) and having a crystal structure known as a layered rock salt structure;
a negative electrode including a negative electrode active material made of a silicon oxide represented by SiOₓ (0.3≦x≦1.6);
a non-aqueous solvent including fluorine (F); and an electrolytic salt.

8. The lithium ion secondary battery according to claim 7, wherein said electrolytic salt includes fluorine (F).

9. The lithium ion secondary battery according to claim 7, wherein said lithium manganese based oxide is Li₂MnO₃.

10. The lithium ion secondary battery according to claim 7, wherein said non-aqueous solvent is one or both of fluoroethylene carbonate and difluoroethylene carbonate.

11. The lithium ion secondary battery according to claim 8, wherein said electrolytic salt is one or both of LiPF₆ and LiBF₄.

12. A vehicle having the lithium ion secondary battery according to claim 7 mounted therein.
